(19) United States
(12) Patent Application Publication
(10) Pub. No.: US 2010/0013599 A1
(43) Pub. Date: Jan. 21, 2010

(54) SMART MONITORING AND WIRELESS QUERY SYSTEM AND METHOD

(75) Inventors: Russell Lewis Tartock, Springfield, IL (US); Aziz Rahman, Springfield, IL (US); Todd Hanson, Loretto, MN (US); Al Cable, Springfield, IL (US); Anthony W. Wilson, Springfield, IL (US)

Correspondence Address: HONEYWELL INTERNATIONAL INC.;PATENT SERVICES, 101 COLUMBIA ROAD, P O BOX 2245, MORRISTOWN, NJ, 07962-2245, US

(73) Assignee: Honeywell International Inc.

(21) Appl. No.: 12/174,378

(22) Filed: Jul. 16, 2008

(51) Int. Cl. H04Q 5/22

(52) U.S. Cl. 340/10.1

(57) ABSTRACT

A smart monitoring and wireless query system is disclosed which includes a sensor suite, an RFID chip, and a microcontroller. The sensor suite with appropriate sensors can be mounted to a separate circuit board installed in a housing of a fixture with the RFID chip in proximity to the sensors. The sensor suite includes, but is not limited to, various sensors for monitoring humidity, light intensity, temperature, and/or power consumption to determine the entire status of a product. A microcontroller can be employed to determine the condition of the fixture from the sensor inputs and convert that information into an RFID signal having a specific timing and pattern. A remote reader can receive said RFID signal pattern from the fixture and can then decode the signal in order to identify which particular fixture from which the signal is received and the status of that particular fixture.

### TECHNICAL FIELD

Embodiments are generally related to sensor methods and systems. Embodiments are also related to radio frequency identification (RFID) technology. Embodiments are additionally related to smart monitoring and wireless query systems.

### BACKGROUND OF THE INVENTION

Monitoring systems are capable of carrying out “intelligent” functions (e.g., detecting, sensing, recording, tracing, communicating, applying scientific logic, etc.) to facilitate decision making, extending shelf life, enhancing safety, improving quality, providing information, and warning about possible problems associated with products on the market today. A “smart” monitoring system should include internal or external sensors for monitoring external conditions (e.g., temperature) or indicator compounds (e.g., volatiles) from the products that can indicate the quality status.

The quality of a packaged product can vary considerably during its useful life. Hence, wireless “smart” monitoring of such products during transportation, storage and use in a chain of logistic is highly desirable. Monitoring the quality during transport and storage in the production chain, for example, provides additional information for predicting the product quality, while also providing important information for logistic control of the supply and distribution chain. Also, package-tampering events, illegal openings, as well as other parameters such as, for example, temperature, pressure, humidity or chemical composition change endured by the products during transportation, storage and use, are to be monitored.

In the majority of prior art monitoring systems, a wire is utilized to transmit information from the sensors to a control module, Due to the nature of wires utilized in many areas of the world, the signal can become degraded or lost and the monitoring system may fail to perform as desired. Additionally, the collected information that is transferred may be limited at best to the basic operation of the utilized electronic device. Such systems, however, require maintenance personnel to examine the product to determine the cause of a fault, which could even be the communication wire that exists between the product and the control module. Therefore, for widespread use of smart monitoring system, a low cost and efficient solution is required.

Based on the foregoing, it is believed a need exists for an improved “smart” monitoring and wireless query based system utilizing RFID technology. Such an improved monitoring method and system is described in greater detail herein.

### BRIEF SUMMARY

The following summary is provided to facilitate an understanding of some of the innovative features unique to the embodiments disclosed and is not intended to be a full description. A full appreciation of the various aspects of the embodiments can be gained by taking the entire specification, claims, drawings, and abstract as a whole.

It is, therefore, one aspect of the present invention to provide for an improved smart monitoring and wireless query system and method.

It is another aspect of the present invention to provide for an improved smart monitoring and wireless query system based on RFID technology.

It is a further aspect of the present invention to provide for a suite of sensors for smart monitoring and wireless query systems.

The aforementioned aspects and other objectives and advantages can now be achieved as described herein. A smart monitoring and wireless query system is disclosed which includes a sensor suite, an RFID chip and a microcontroller. The sensor suite with appropriate sensors can be mounted to a separate circuit board installed in a housing of a fixture with the RFID chip in proximity to the sensors. The sensor suite includes, but is not limited to, various sensors for monitoring humidity, light intensity, temperature, and/or power consumption to determine the entire status of a product. A microcontroller can be employed to determine the condition of the fixture from the sensor inputs and convert that information into an RFID signal having a specific timing and pattern. A remote reader can receive said RFID signal pattern from the fixture and can then decode the signal in order to identify which particular fixture from which the signal is received and the status of that particular fixture. The remote reader also can provide an alert to maintenance personnel and a submission of current status information including, but not limited to, the nature of any fault condition to an end-user device.

The RFID chip utilized can wirelessly indicate the health of the system through predetermined timing of ID pulses in a short time period. Additionally, the RFID communication quickly determines which fixture is malfunctioning and the fault condition can be sent to alert maintenance personnel for repair. Such a “smart” monitoring system thus provides a low cost solution for wireless monitoring of products including those having large dimensions, while also capable of monitoring the status of the product.

### BRIEF DESCRIPTION OF THE DRAWINGS

The accompanying figures, in which like reference numerals refer to identical or functionally-similar elements throughout the separate views and which are incorporated in and form a part of the specification, further illustrate the embodiments and, together with the detailed description, serve to explain the embodiments disclosed herein.

FIG. 1 illustrates a block diagram of a “smart” monitoring and wireless query system, which can be implemented in accordance with a preferred embodiment;

FIG. 2 illustrates a schematic block diagram of a “smart” monitoring and wireless query system, which can be implemented in accordance with a preferred embodiment; and

FIG. 3 illustrates a high level flow chart of operations illustrating logical operational steps of a method for “smart” wireless monitoring of products, which can be implemented in accordance with a preferred embodiment.

### DETAILED DESCRIPTION

The particular values and configurations discussed in these non-limiting examples can be varied and are cited merely to illustrate at least one embodiment and are not intended to limit the scope thereof.

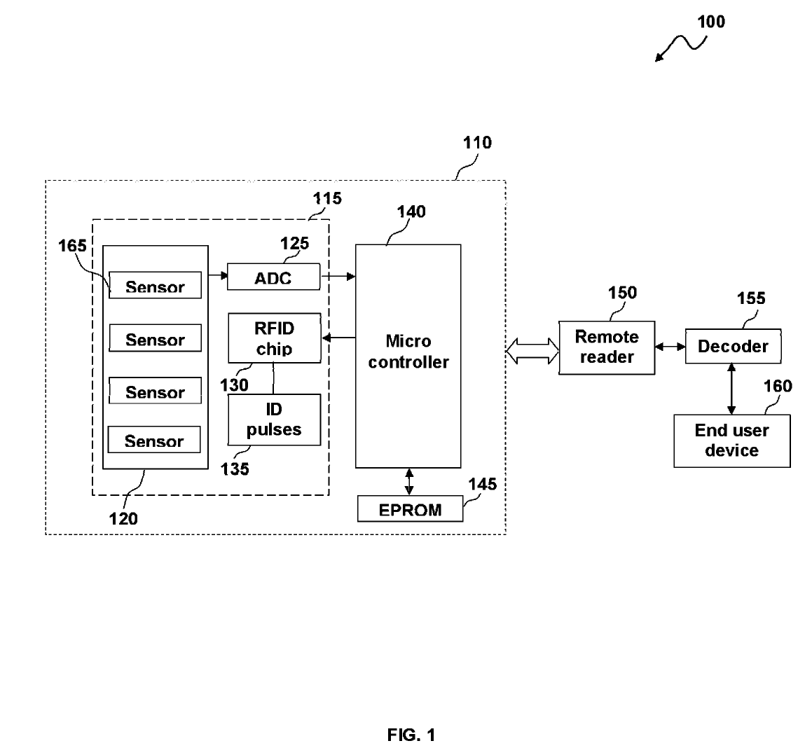

FIG. 1 illustrates a block diagram of a smart monitoring and wireless query system 100, in accordance with the preferred embodiment. The smart monitoring and wireless query system 100 generally includes a sensor suite 120, an RFID chip 130 and a microcontroller 140. The sensor suite 120 includes a number of sensors 165 for monitoring, for example, humidity, light intensity, temperature, and/or power consumption to determine the entire status of a product. The sensor suite 120 with appropriate sensors 165 can be mounted to a separate circuit board 115 installed in a housing of a fixture 110 with the RFID chip 130 placed in proximity to the sensors 165. The system 100 further may include an analog-to-digital converter 125, which can be utilized to convert the signals generated by the sensors 165 to a digital signal. The analog-to-digital converter 125 may be bypassed in such cases where the signal from the sensors 165 is digital in nature or where the microcontroller 140 includes an analog to digital convertor.

The RFID chip 130 wirelessly indicates the health of the smart monitoring and wireless query system 100 through a predetermined timing of ID pulses 135. A microcontroller 140 determines the status of the fixture 110 via inputs from the sensor suite 120 through the analog-to-digital converter 125 as appropriate and adjusts the timing and pattern of the RFID signal 135 to indicate the condition of the fixture 110. The RFID chip 130 transmits the ID pulses 135 to a remote reader 150. The fixture 110 may optionally include a memory 145. Memory 145 stores processed information from the sensors 165, microcontroller 140, and RFID chip 130. The information may be stored permanently or temporarily. In an embodiment of the present invention, memory 145 is a programmable memory. The stored information may be utilized internally by the microcontroller 140 or may be communicated for use externally by the wireless remote reader 150 and an end user device 160. The remote reader 150 receives the signal 135 from the fixture 110 and decodes the ID pulses 135 utilizing a decoder 155 in order to identify the particular fixture 110 from which the signal is received and its current status. The decoded signal can be utilized by the end user device 160, which represents the status of the product in the fixture 110. The end user device 160 also includes logic to process received data from the fixture 110. The RFID chip 130 also identifies which particular fixture is being read and indicates an alert to maintenance personnel in the event of a malfunction or malfunctions.

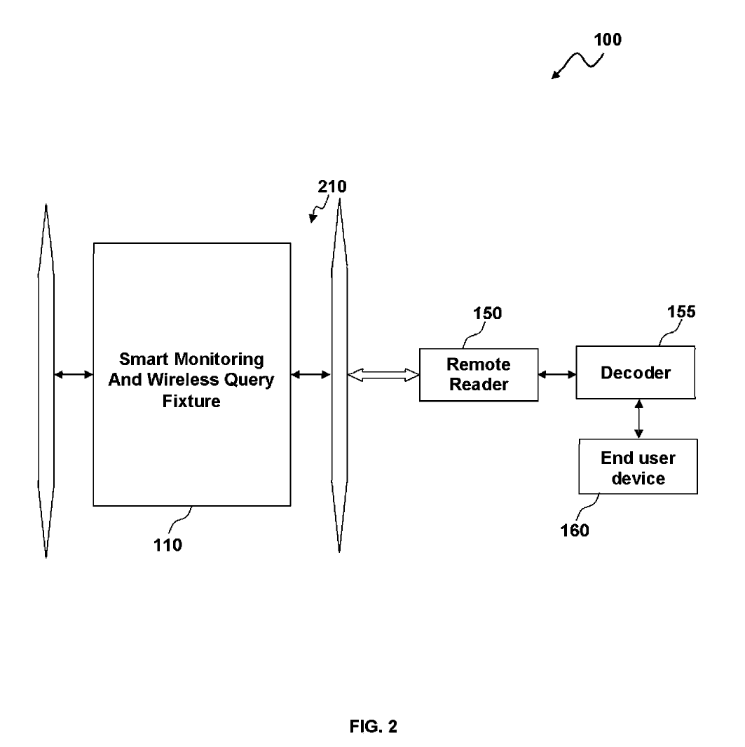

FIG. 2 illustrates a schematic block diagram of the smart monitoring and wireless query system 100 on a wide area network (WAN) 210. Note that in FIGS. 1-3, identical or similar parts are generally indicated by identical reference numerals. A wide area network (WAN) 210 connects the circuit board 115 associated with the fixture 110 to the end-user device 160. The circuit board 115 can be implemented as an application specific device having the microcontroller 140, memory 145 and appropriate communication ports, or as a standard personal computer running application specific software. The microcontroller 140 controls the overall operation of the circuit board 115 and communicates with the sensors 165 directly or via the analog-to-digital converter 125. The signals from the fixture 110 can be wirelessly transmitted to the remote reader 150.

The system 100 can be utilized to provide real-time on-demand status information to end-user device 160, as well as alarm notifications to the end-user and other appropriate entities if certain pre-defined conditions and/or events are detected. The suite of sensors 165 is typically, but not exclusively, a conventional transducer for measuring a particular parameter and provides analog signals indicating the measured parameter to the ADC 125 for conversion to digital signals compatible with the microcontroller 140. The ADC 125 may be bypassed in the event that the signal from the sensor is digital or the microcontroller 140 includes a built-in analog-to-digital converter. Events are defined as changes in a monitored input (of a sensor 165) that result in the performance of an action. An event report may be sent to the user and/or stored on the EPROM 145 when the circuit board 115 detects a valid event.

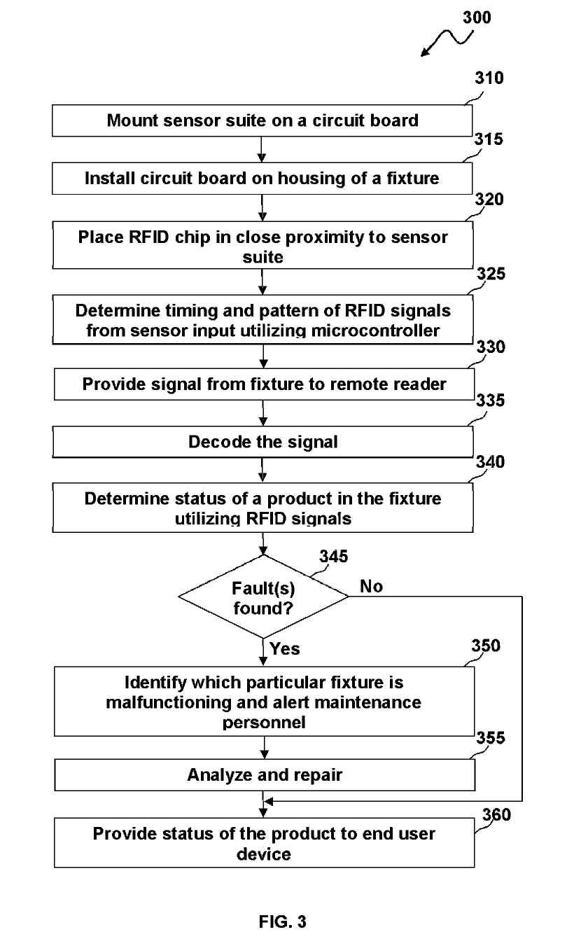

FIG. 3 illustrates a high level flow chart of operations 300 illustrating logical operational steps for smart wireless monitoring of products, in accordance with the preferred embodiment. A sensor suite 120 can be mounted on a circuit board 115, as illustrated at block 310. The circuit board 115 can be installed on a housing of a fixture 110, as depicted at block 315. An RFID chip 130 can be placed in close proximity to the sensor suite 120, as illustrated at block 320. The RFID chip 130 wirelessly indicates health of the system through a predetermined timing of ID pulses 135. A microcontroller 140 can be utilized to determine the status of the fixture 110 via inputs from the sensor suite 120, through the analog-to-digital converter 125 as appropriate, and adjusts the timing and pattern of the RFID signal 135 to indicate the condition of the fixture 110, as depicted at block 325. The signal from the fixture 110 can be provided to the remote reader 150, as depicted at block 330. The received signal can be decoded, as depicted at block 335. The status of a product in the fixture 110 can be determined by utilizing the RFID signals, as depicted at block 340.

As depicted at block 345, a determination can be made whether a fault is found. If a fault is found, the RFID chip 130 identifies which particular fixture is being read and provides an alert to maintenance personnel as to the nature of the malfunction in the event of a fault, as illustrated at block 350. The fault can be analyzed and repaired, as depicted at block 355. The decoded signal can be submitted to an end-user device 160 representing the status of the product in the fixture 110, as depicted at block 360. The RFID chip 130 remotely communicates the health of the system 100 through the predetermined timing of ID pulses 135 in less time. Additionally, the RFID communication quickly determines which fixture is malfunctioning and the fault in order to alert maintenance personnel for the repair. Such smart monitoring system 100 provides a low cost solution for wireless monitoring of products including large dimensions ones and also monitors the status of the product.

It will be appreciated that variations of the above-disclosed and other features and functions, or alternatives thereof, may be desirably combined into many other different systems or applications. Also that various presently unforeseen or unanticipated alternatives, modifications, variations or improvements therein may be subsequently made by those skilled in the art which are also intended to be encompassed by the following claims.

What is claimed is:

1. A smart monitoring and wireless query system comprising:
at least one sensor mounted in a circuit board for determining a status of a product, wherein said at least one sensor is installed in a housing of a fixture in association with a microcontroller that receives a signal from said at least one sensor to determine said status of said product;
an RFID chip placed in close proximity to said at least one sensor and said microcontroller for receiving a plurality of signals from said microcontroller, wherein said RFID chip is capable of transmitting an RFID signal in a predetermined timing and pattern; and
a remote reader for receiving said RFID signal from said fixture and decoding said signal to identify a fixture and to provide the current status thereof, including but not limited to varying fault conditions, thereby permitting wireless monitoring of said product.

2. The system of claim 1 wherein said RFID chip remotely communicates said current status of said product through a predetermined timing of ID pulses.

3. The system of claim 1 wherein said RFID chip identifies said malfunction associated with said fixture and alert maintenance personnel.

4. The system of claim 1 wherein at least one sensor comprises a pressure sensor.

5. The system of claim 1 wherein said at least one sensor comprises a temperature sensor.

6. The system of claim 1 wherein said at least one sensor comprises a chemical sensor.

7. The system of claim 1 wherein said at least one sensor comprises a sensor for monitoring a pressure, a temperature, a power consumption and/or a chemical composition associated with said product.

8. The system of claim 1 further comprising a memory coupled with said microcontroller for storing information from said at least one sensor and said RFID chip.

9. The system of claim 1 further comprising an analog-to-digital converter coupled to said at least one sensor.

10. The system of claim 1 further comprising a microcontroller that includes an analog-to-digital converter.

11. A smart monitoring and wireless query system comprising:
at least one sensor mounted in a circuit board for determining a status of a product, wherein said at least one sensor is installed in a housing of a fixture in association with a microcontroller that receives a signal from said at least one sensor to determine said status of said product;
an RFID chip placed in close proximity to said at least one sensor and said microcontroller for receiving a plurality of signals from said microcontroller, wherein said RFID chip is capable of transmitting an RFID signal in a predetermined timing and pattern; and
a remote reader for receiving said RFID signal from said fixture and decoding said signal to identify a fixture and to provide the current status thereof, including but not limited to varying fault conditions, thereby permitting wireless monitoring of said product wherein said RFID chip remotely communicates said current status of said product through a predetermined timing of ID pulses.

12. The system of claim 11 further comprising:
a memory coupled with said microcontroller for storing information from said at least one sensor and said RFID chip;
an analog-to-digital converter coupled to said at least one sensor; and
wherein said microcontroller includes said analog-to-digital converter.

13. The system of claim 12 wherein at least one sensor comprises a pressure sensor.

14. The system of claim 12 wherein said at least one sensor comprises a temperature sensor.

15. The system of claim 12 wherein said at least one sensor comprises a chemical sensor.

16. A smart monitoring and wireless query method, comprising:
mounting at least one sensor in a circuit board for determining a status of a product;
installing said at least one sensor in a housing of a fixture in association with a microcontroller that receives a signal from said at least one sensor to determine said status of said product;
locating an RFID chip in close proximity to said at least one sensor and said microcontroller for receiving a plurality of signals from said microcontroller, wherein said RFID chip is capable of transmitting an RFID signal in a predetermined timing and pattern; and
permitting a remote reader to receive said RFID signal from said fixture and decoding said signal to identify a fixture and to provide the current status thereof, including, but not limited to, varying fault conditions, thereby permitting wireless monitoring of said product.

17. The method of claim 16 further comprising configuring said RFID chip to remotely communicate said current status of said product through a predetermined timing of ID pulses.

18. The method of claim 16 wherein said at least one sensor comprises a sensor for monitoring a pressure, a temperature, a power consumption and/or a chemical composition associated with said product.

19. The method of claim 16 further comprising:
electrically connecting a memory to said microcontroller for storing information from said at least one sensor and said RFID chip;
coupling an analog-to-digital converter to said at least one sensor.

20. The method of claim 16 further comprising providing a microcontroller that includes said analog-to-digital converter in association with said memory.
